(19) United States
(12) Patent Application Publication
(10) Pub. No.: US 2017/0111854 A1
(43) Pub. Date: Apr. 20, 2017

(54) QUALITY OF SERVICE AWARE ACCESS POINT AND DEVICE STEERING

(71) Applicant: QUALCOMM Incorporated, San Diego, CA (US)

(72) Inventors: Sai Yiu Duncan Ho, San Diego, CA (US); Brian Michael Buesker, San Diego, CA (US); Yanjun Sun, San Diego, CA (US); Peerapol Tinnakornsrisuphap, San Diego, CA (US)

(21) Appl. No.: 15/186,284

(22) Filed: Jun. 17, 2016

Related U.S. Application Data
(60) Provisional application No. 62/242,227, filed on Oct. 15, 2015.

(51) Int. Cl. H04W 48/20; H04B 7/14; H04W 24/02; H04W 36/08; H04W 36/22; H04W 36/16

(52) U.S. Cl. CPC H04W 48/20; H04W 36/22; H04W 36/165; H04W 24/02; H04W 36/08; H04B 7/14; H04W 84/12

(57) ABSTRACT

Apparatuses and methods are disclosed that may allow a wireless device to be steered between a number of different access points (APs) based, at least in part, on a type of traffic associated with the wireless device. In some aspects, a first AP may monitor a traffic flow associated with the wireless device, identify a traffic type of the traffic flow based on one or more characteristics of the traffic flow, and selectively switch an association of the wireless device between the first AP and one of a number of second APs based, at least in part, on the identified traffic type.

This application claims priority under 35 USC 119(e) to co-pending and commonly owned U.S. Provisional Patent Application No. 62/242,227 entitled “QUALITY OF SERVICE AWARE ACCESS POINT AND BAND STEERING” filed on Oct. 15, 2015, the entirety of which is incorporated by reference herein.

### TECHNICAL FIELD

The example embodiments relate generally to wireless networks, and specifically to steering wireless devices between different access points and/or between different frequency bands.

### BACKGROUND OF RELATED ART

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and/or maintain a communication link with the WLAN. In a typical WLAN, only one STA may use the wireless medium at any given time, and each STA may be associated with only one AP at a time.

Due to the increasing ubiquity of wireless networks, when a STA seeks to join a wireless network, the STA may have a choice between multiple wireless networks and/or between multiple APs that form an extended BSS. For example, many home wireless networks employ a root AP (e.g., a base station) and multiple relay devices (e.g., “repeaters”) to extend the effective wireless coverage area of the root AP. Further, some APs and STAs are capable of operating on a number of different frequency bands including, for example, the 2.4 GHz frequency band, the 5 GHz frequency band, and the 60 GHz frequency band. Thus, in addition to selecting an AP with which to associate, the STA may also select a given frequency band upon which to operate.

After the STA is associated with the selected AP on a selected frequency band, the STA may be moved within the wireless network, and may benefit by switching its association from the selected AP to one of a number of candidate APs (e.g., that may offer better service than the selected AP) and/or by switching to another frequency band. As more STAs join the wireless network, the overall load on each AP and/or frequency band may become imbalanced, which may undesirably result in a less than optimal allocation of the wireless network's capacity.

### SUMMARY

This Summary is provided to introduce in a simplified form a selection of concepts that are further described below with respect to the Detailed Description. This Summary is not intended to identify key features or essential features of the claimed subject matter, nor is it intended to limit the scope of the claimed subject matter.

Apparatuses and methods are disclosed that may allow a wireless device to be steered between a number of different access points based, at least in part, on a type of traffic associated with the wireless device. In one example, a method of selectively steering a wireless device between a first access point (AP) and a number of second APs in a wireless local area network (WLAN) is disclosed. The method may include monitoring a traffic flow associated with the wireless device; identifying a traffic type of the traffic flow based, at least in part, on one or more characteristics of the traffic flow; and selectively switching an association of the wireless device from the first AP to one of the number of second APs based, at least in part, on the identified traffic type. In some aspects, the first AP may be a root AP, and each of the second APs may be a repeater AP. In other aspects, the first AP may be a repeater AP, and one of the second APs may be a root AP.

In another example, a first AP is disclosed. The first AP may include one or more processors and a memory. The memory may store instructions that, when executed by the one or more processors, cause the first AP to selectively steer a wireless device between the first AP and a number of second APs in a WLAN by monitoring a traffic flow associated with the wireless device; identifying a traffic type of the traffic flow based, at least in part, on one or more characteristics of the traffic flow; and selectively switching an association of the wireless device from the first AP to one of the number of second APs based, at least in part, on the identified traffic type. In some aspects, the first AP may be a root AP, and each of the second APs may be a repeater AP. In other aspects, the first AP may be a repeater AP, and one of the second APs may be a root AP.

In another example, a non-transitory computer-readable medium is disclosed. The non-transitory computer-readable medium may store one or more programs containing instructions that, when executed by one or more processors of a first AP, cause the first AP to selectively steer a wireless device between the first AP and a number of second APs in a WLAN by performing operations comprising monitoring a traffic flow associated with the wireless device; identifying a traffic type of the traffic flow based, at least in part, on one or more characteristics of the traffic flow; and selectively switching an association of the wireless device from the first AP to one of the number of second APs based, at least in part, on the identified traffic type. In some aspects, the first AP may be a root AP, and each of the second APs may be a repeater AP. In other aspects, the first AP may be a repeater AP, and one of the second APs may be a root AP.

In another example, a first AP for selectively steering a wireless device between the first AP and a number of second APs in a WLAN is disclosed. The first AP may include means for monitoring a traffic flow associated with the wireless device; means for identifying a traffic type of the traffic flow based, at least in part, on one or more characteristics of the traffic flow; and means for selectively switching an association of the wireless device from the first AP to one of the number of second APs based, at least in part, on the identified traffic type. In some aspects, the first AP may be a root AP, and each of the second APs may be a repeater AP. In other aspects, the first AP may be a repeater AP, and one of the second APs may be a root AP.

### BRIEF DESCRIPTION OF THE DRAWINGS

The example embodiments are illustrated by way of example and are not intended to be limited by the figures of the accompanying drawings.

FIG. 1 shows a block diagram of a wireless system within which the example embodiments may be implemented.

FIG. 2 shows a block diagram of a wireless station (STA) in accordance with example embodiments.

FIG. 3 shows a block diagram of an access point (AP) in accordance with example embodiments.

FIG. 4 shows a block diagram of a packet contention and transmission system of the AP of FIG. 3 in accordance with example embodiments.

FIG. 5 shows an illustrative flow chart depicting an example operation for steering a wireless device to a particular AP of the wireless system of FIG. 1.

Like reference numerals refer to corresponding parts throughout the drawing figures.

### DETAILED DESCRIPTION

The example embodiments are described below in the context of steering a wireless device in a WLAN including a root AP and a number of repeaters for simplicity only. It is to be understood that the example embodiments are equally applicable to steering wireless devices in other WLAN configurations and/or other suitable wireless networks (e.g., cellular networks, pico networks, femto networks, satellite networks). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including an AP and a plurality of STAs, the example embodiments are equally applicable to other WLAN systems including, for example, WLANs including a plurality of APs, peer-to-peer (or Independent Basic Service Set) systems, Wi-Fi Direct systems, and/or Hotspots. In addition, although described herein in terms of exchanging data packets between wireless devices, the example embodiments may be applied to the exchange of any data unit, packet, and/or frame between wireless devices. Thus, the term “data packet” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “medium access” as used herein may refer to gaining and/or controlling access to a shared wireless medium. The term “transmit opportunity” (TXOP) as used herein may refer to a period of time during which a device (or a portion of the device) may transmit data via the shared wireless medium. The term “access category” refers to data that may be queued together or aggregated according to priority level. The priority level of packets and/or of a flow to which the packets belong may indicate an importance of such packets relative to packets belonging to other flows. For example, higher priority traffic may be given more frequent access to the shared wireless medium, longer access to the shared wireless medium, and/or a greater portion of the available bandwidth of the shared wireless medium than lower-priority traffic.

The term “associated AP” refers to an AP with which a given STA is associated (e.g., there is an established communication channel or link between the AP and the given STA). The term “non-associated AP” refers to an AP with which a given STA is not associated (e.g., there is not an established communication channel or link between the AP and the given STA, and thus the AP and the given STA may not yet exchange data frames). The non-associated APs may also be referred to herein as “candidate APs,” and thus the terms “non-associated AP” and “candidate AP” may be used interchangeably herein.

Further, the terms “goodput” and “throughput” may refer to an effective data rate of a wireless channel or link between two wireless devices (e.g., between a STA and an AP). The term “goodput” may be used interchangeably with the term “throughput” in the following description. For example embodiments, the goodput of an AP may be indicative of the available bandwidth of a wireless channel upon which the AP operates, and thus may also be indicative of the amount of traffic on the wireless channel.

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The example embodiments are not to be construed as limited to specific examples described herein but rather to include within their scopes all embodiments defined by the appended claims.

As mentioned above, when a wireless device such as a STA is moved into the coverage area of one or more wireless networks, it may be desirable to select the best available AP with which the STA is to associate. As used herein, the term “best available AP” may refer to the AP that provides the highest goodput (e.g., as compared with the goodput of other nearby APs). After the STA becomes associated with a particular AP, it may be desirable to continually (or periodically) determine whether one or more candidate APs may offer the STA better goodput than the AP with which the STA is currently associated. In certain situations, for example during a Voice Over IP (VoIP) call, other metrics such as latency and jitter may also be factored in when determining the best available AP.

Because many APs have dual-band capabilities, it may also be desirable to consider other frequency bands when selecting the best available AP for a STA. For example, dual-band APs that are compliant with the IEEE 802.11 ac standards may simultaneously operate on the 2.4 GHz and 5 GHz frequency bands. A STA that is currently associated with such a dual-band AP on one frequency band may obtain better goodput from the same AP on another frequency band. For one example, because higher-frequency wireless signals typically have shorter range than lower-frequency wireless signals, a STA that is moving away from a dual-band AP may obtain better throughput by switching from the 5 GHz frequency band to the 2.4 GHz frequency band. For another example, although higher-frequency wireless signals may have higher data rates than lower-frequency wireless signals, if the 5 GHz frequency band is congested, then the STA may obtain better throughput by switching from the 5 GHz frequency band to the 2.4 GHz frequency band (e.g., if the 2.4 GHz frequency band is less congested than the 5 GHz frequency band).

The priority level of data transmitted (or to be transmitted) on a shared wireless medium may also be important in determining the best available AP with which to associate. In addition, because data priority levels may be an important consideration when balancing traffic flows across a wireless network and/or when balancing the loads between multiple APs, data priority levels may also be important when steering wireless devices such as STAs to a particular AP and/or to a particular frequency band. For example, because APs may transmit higher-priority data sooner and/or more frequently than lower-priority data, identifying the priority level of data and/or traffic flows associated with a particular STA may be useful for not only selecting the best available AP but also maintaining balanced loads between multiple APs of the wireless network. These are at least some of the technical problems to be solved by the example embodiments.

Thus, apparatuses and methods are disclosed that may allow a number of wireless devices such as STAs to be dynamically steered between different frequency bands and/or between different APs in a manner that not only maintains a balanced load across the wireless network but also ensures that Quality of Service (QoS) demands of the wireless devices are met. In some aspects, the example embodiments may take into account QoS attributes, data priority levels, traffic flows and types, packet classifications, and/or other suitable parameters when steering a wireless device between different APs and/or between different frequency bands. In certain aspects, the overall load of the WLAN may increase such that the long-term benefits of steering the wireless device to a particular AP (e.g., steering the wireless device to a root AP to reduce the number of hops regardless of location of the wireless device) may outweigh the short-term costs (e.g., low signal strength while the wireless device is moving). These and other details of the example embodiments, which may provide one or more solutions to the aforementioned technical problems, are described in more detail below.

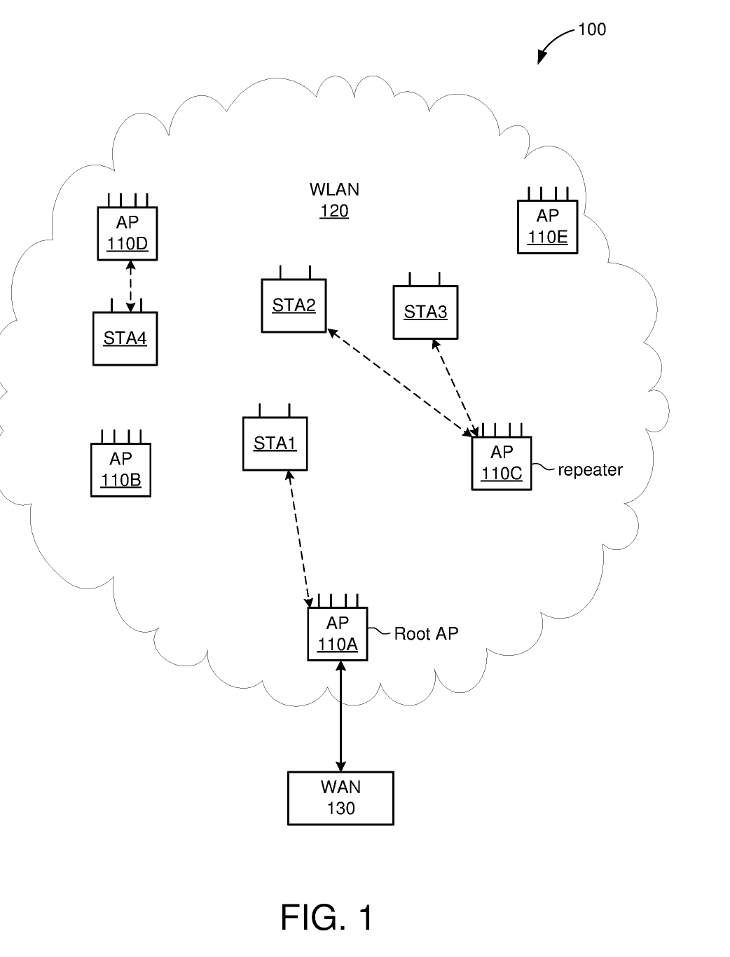

FIG. 1 shows a block diagram of an example wireless system 100 within which the example embodiments may be implemented. The wireless system 100 is shown to include four wireless stations STA1-STA4, five wireless access points (APs) 110A-110E, and a wireless local area network (WLAN) 120. The WLAN 120 may be formed by any number of APs that may operate according to the IEEE 802.11 family of standards (or according to other suitable wireless protocols). Thus, although only five APs 110A-110E are shown in FIG. 1 for simplicity, it is to be understood that WLAN 120 may be formed by any number of APs. Each of APs 110A-110E is assigned a unique media access control (MAC) address that is programmed therein by, for example, the manufacturer of the AP. Similarly, each of the stations STA1-STA4 is also assigned a unique MAC address.

For some embodiments, the WLAN 120 may allow for multiple-input multiple-output (MIMO) communications between the APs 110A-110E and stations STA1-STA4. The MIMO communications may include single-user MIMO (SU-MIMO) and/or multi-user MIMO (MU-MIMO) communications. Further, although the WLAN 120 is depicted in FIG. 1 as an infrastructure BSS, for other example embodiments, WLAN 120 may be an independent basic service set (IBSS), an ad-hoc network, or a peer-to-peer (P2P) network (e.g., operating according to the Wi-Fi Direct protocols).

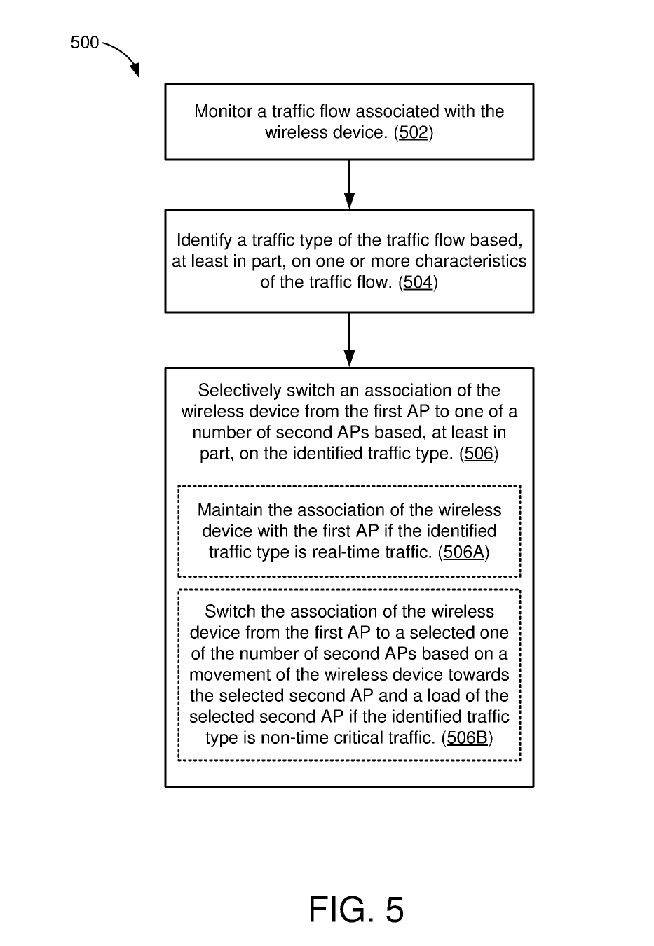

Each of the stations STA1-STA4 may be any suitable Wi-Fi enabled wireless device including, for example, a cell phone, personal digital assistant (PDA), tablet device, laptop computer, gaming console, television, streaming device, or the like. Each of the stations STA1-STA4 may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client device, or some other suitable terminology. For at least some embodiments, each of the stations STA1-STA4 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 5.

The APs 110A-110E may be any suitable device that allows one or more wireless devices to connect to a network (e.g., a local area network (LAN), wide area network (WAN), metropolitan area network (MAN), and/or the Internet) using Wi-Fi, Bluetooth, or any other suitable wireless communication standards. For at least some embodiments, each of APs 110A-110E may include one or more transceivers, a network interface, one or more processing resources, and one or more memory resources. The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 5.

For the APs 110A-110E and/or the stations STA1-STA4 of FIG. 1, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the STA may be any technically feasible transceiver such as a ZigBee transceiver described by a specification from the ZigBee specification, a WiGig transceiver, and/or a HomePlug transceiver described a specification from the HomePlug Alliance.

For the example wireless system 100 of FIG. 1, AP 110A may operate as the root AP, and the remaining APs 110B-110E may operate as repeaters (or “range extenders”). The root AP 110A may be connected to an external WAN 130 (e.g., the Internet or some other suitable backhaul network) via a wired connection. The repeater APs 110B-110E may each be connected to the root AP 110A (and/or to each other) via a shared wireless medium associated with the WLAN 120. The shared wireless medium may include any suitable number of channels occupying any suitable number of frequency bands. Thus, for the wireless system 100 depicted in FIG. 1, the APs 110A-110E may share the same wireless channels for backhaul (e.g., wireless communications between the root AP 110A and the repeater APs 110B-110E) and for access links (e.g., wireless communications between stations STA1-STA4 and the APs 110A-110E).

For at least some embodiments, the root AP 110A may monitor the channel conditions of the channel currently used by the APs 110A-110E. If the root AP 110A determines that better goodput may be possible on another channel or frequency band (e.g., due to traffic on the current channel, channel interference caused by a neighboring wireless network, and so on), the root AP 110A may switch channels, for example, by broadcasting a channel switch announcement. In response thereto, the repeater APs 110B-110E may coordinate their channel switching operations with the root AP 110A. Because all the stations STA1-STA4 may need to re-associate with their respective associated APs when switching channels, the root AP 110A may select or schedule a time to initiate the channel switch operation based, at least in part, on one or more characteristics of the traffic flows associated with the stations STA1-STA4, for example, to minimize service interruptions caused by channel switch operations.

For some embodiments, the WLAN 120 of FIG. 1 may operate according to the enhanced distributed coordination channel access (EDCA) function described in the IEEE 802.11 standards. For these embodiments, each of stations STA1-STA4 may include a different transmit queue for each access category (AC), and the transmit queues are to independently contend for medium access. Because the APs 110A-110E may serve multiple clients at the same time, each of the APs 110A-110E may include a plurality of transmit queues for each AC. More specifically, the APs 110A-110E may classify downlink data (e.g., data to be transmitted to one or more of its associated STAs) based on a traffic identifier (TID) and a destination address (DA). The destination address (DA) indicates to which STA the data is to be transmitted. The TID indicates the priority level of the data, and may thus be mapped to a corresponding access category. By classifying downlink data according to its TID and DA, each AP may aggregate data of the same priority level in a common set of AC queues that select from a corresponding range of back-off numbers (e.g., used for medium access contention operations).

For at least some embodiments described herein, data may be assigned to one of four access categories (ACs): the highest priority data (e.g., voice data) may be assigned to a first access category (AC_VO); the second highest priority data (e.g., video data) may be assigned to a second access category (AC_VI); the third highest priority data (e.g., data associated with a “best effort” QoS) may be assigned to a third access category (AC_BE); and the lowest priority data (e.g., background data) may be assigned to a fourth access category (AC_BK). Although the four access categories described herein correspond to the access categories (AC_VO, AC_VI, AC_BE, and AC_BK) defined in the IEEE 802.11 standards, for other embodiments, the access categories described herein may be applicable to access categories or priority levels for other wireless protocols (e.g., cellular and Bluetooth®) and/or to wired protocols (e.g., Internet Protocol, Ethernet, HomePlug, powerline, EPON, EPOC, and so on).

As depicted in FIG. 1, station STA1 is currently associated with the root AP 110A, stations STA2-STA3 are both currently associated with the repeater AP 110C, and station STA4 is currently associated with the repeater AP 110D. It may be desirable to periodically consider steering the stations STA1-STA4 to other APs and/or other frequency bands based, at least in part, on factors that may include (but not limited to) changes in the load balance on the APs 110A-110E, changes in traffic characteristics, changes in locations of the stations STA1-STA4, changes in bandwidth or service needs of the stations STA1-STA4, changes in channel conditions, and/or changes in goodput of the APs 110A-110E. In some aspects, it may be desirable to maintain the association of station STA4 with repeater AP 110D based, at least in part, on the type of traffic addressed to station STA4 (e.g., when station STA4 is receiving real-time traffic such as, for example, gaming traffic or a VoIP call). Therefore, unless the client wants to change association of STA4 with repeater 110D, the real-time traffic may not be interrupted even if there is a stronger AP available. Similarly, it may be desirable to maintain the association of station STA1 with root AP 110A based, at least in part, on the type of traffic addressed to STA1, for example, in order to minimize the number of hops for such traffic. Thus, in accordance with the example embodiments, a selected AP (such as root AP 110A) may consider at least the above-mentioned factors when steering the stations STA1-STA4 between different APs and/or between different frequency bands. In addition, for some embodiments, the selected AP may also selectively throttle traffic flows and/or alter the priority levels of traffic flows in conjunction with AP steering operations and/or frequency band steering operations.

Traffic characteristics may include a flow's QoS and application type. QoS may be defined as a set of parameters that allows for the allocation of different levels of network services to different traffic flows. For example, when traffic through a network switch exceeds its bandwidth capacity, QoS parameters may be used to shape and/or police network traffic to ensure certain minimum service guarantees and to alleviate network congestion. QoS parameters for network traffic are typically defined by a service level agreement (SLA) in which a service provider contracts to transport packets of data across the service provider's network with certain assurances on the quality of the transport. The SLA may specify customer expectations of performance in terms of availability, packet delay, packet loss, priority, and bandwidth for specific types of traffic flow. For internet protocol (IP) traffic, traffic flows may be classified as constant bit rate (CBR) traffic, variable bit rate (VBR) traffic, unspecified bit rate (UBR) traffic, and available bit rate (ABR) traffic.

For the example embodiments described herein, the root AP 110A may classify traffic flows as one of the following local traffic types: real-time traffic (e.g., gaming traffic or voice traffic), streaming traffic (e.g., video traffic), general traffic, and bulk traffic. Each of the local traffic types may have an implicit QoS demand. For example, real-time traffic may imply a need for low delay and low jitter, while bulk traffic may imply that data throughput is more important than packet delay. Thus, for at least some implementations, real-time traffic may correspond to CBR traffic (e.g., voice traffic), while bulk traffic may correspond to ABR traffic (e.g., best-effort traffic).

More specifically, the root AP 110A may classify incoming traffic flows (e.g., traffic flows received by the root AP 110A from the WAN 130) by analyzing incoming packets for QoS markers and/or application type. If an incoming packet or traffic flow does not have any QoS markings (e.g., because the QoS markings were stripped by the service provider), then the root AP 110A may perform deep packet inspection (or other suitable technique) on the packets to classify incoming traffic flows based on flow characteristics such as, for example, data rate, flow length or duration, flow ID, and so on. The root AP 110A may also be able to determine a type of device to which the flow is intended (e.g., television, gaming console, smartphone, and so on). Thereafter, the root AP 110A may make device steering decisions based, at least in part, on the traffic classifications and/or device type. In some aspects, the root AP 110A may also consider movement of a station when determining whether to steer the station to a different AP and/or to a different frequency band.

For one example, if STA1 is receiving a real-time VoIP flow and is moving away from the root AP 110A towards the repeater AP 110D, the root AP 110A may decide to not steer STA1 to the repeater AP 110D to avoid potential interruptions, even though the repeater AP 110D may be able to offer STA1 better goodput than the root AP 110A. Therefore, in some aspects, the decision to maintain the association of STA1 with the root AP 110A may be independent of the load on the repeater AP 110D (e.g., regardless of the load on the repeater AP 110D). For another example, if STA4 has bulk traffic (e.g., a bulk backup operation from STA4 to a cloud storage device) and is moving away from repeater AP 110D towards repeater AP 110B, then the root AP 110A may consider the potential impact on the load of repeater AP 110B prior to steering STA4 to repeater AP 110B (e.g., because once STA4 is steered to repeater AP 110B, the bulk traffic may increase and consume more of repeater AP 110B's bandwidth than expected).

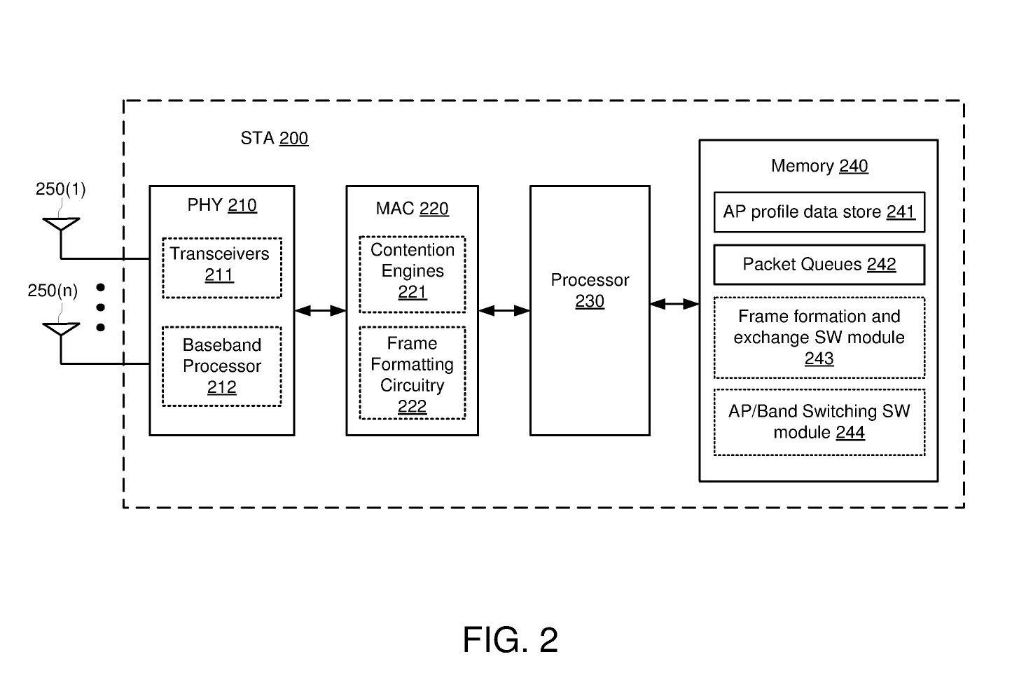

FIG. 2 shows an example STA 200 that may be an embodiment of one or more of the stations STA1-STA4 of FIG. 1. The STA 200 may include a PHY device 210 including at least a number of transceivers 211 and a baseband processor 212, may include a MAC 220 including at least a number of contention engines 221 and frame formatting circuitry 222, may include a processor 230, may include a memory 240, and may include a number of antennas 250(1)-250(n).

The transceivers 211 may be coupled to antennas 250(1)-250(n), either directly or through an antenna selection circuit (not shown for simplicity). The transceivers 211 may be used to transmit signals to and receive signals from APs 110A-110E and/or other wireless devices (see also FIG. 1), and may be used to scan the surrounding environment to detect and identify nearby access points and/or other wireless devices (e.g., within wireless range of STA 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for example embodiments, the STA 200 may be configured for MIMO operations. The MIMO operations may include single-user MIMO (SU-MIMO) operations and multi-user MIMO (MU-MIMO) operations.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

The contention engines 221 may contend for access to one or more shared wireless mediums, and may also store packets for transmission over the one or more shared wireless mediums. The STA 200 may include one or more contention engines 221 for each of a plurality of different access categories. For other embodiments, the contention engines 221 may be separate from MAC 220. For still other embodiments, the contention engines 221 may be implemented as one or more software modules (e.g., stored in memory 240 or stored in memory provided within MAC 220) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY device 210 (e.g., by stripping MAC headers from frames received from PHY device 210).

For purposes of discussion herein, MAC 220 is shown in FIG. 2 as being coupled between PHY device 210 and processor 230. For actual embodiments, PHY device 210, MAC 220, processor 230, and/or memory 240 may be connected together using one or more buses (not shown for simplicity).

Memory 240 may include an AP profile data store 241 that stores profile information for a plurality of APs. The profile information for a particular AP may include, for example, the AP's location, service set identification (SSID), media access control (MAC) address, channel information, received signal strength indicator (RSSI) values, goodput values, channel state information (CSI), timing information, supported data rates, supported frequency bands, connection history with STA 200, supported and/or recently used modulation and coding schemes, and any other suitable information pertaining to or describing the operation of the AP.

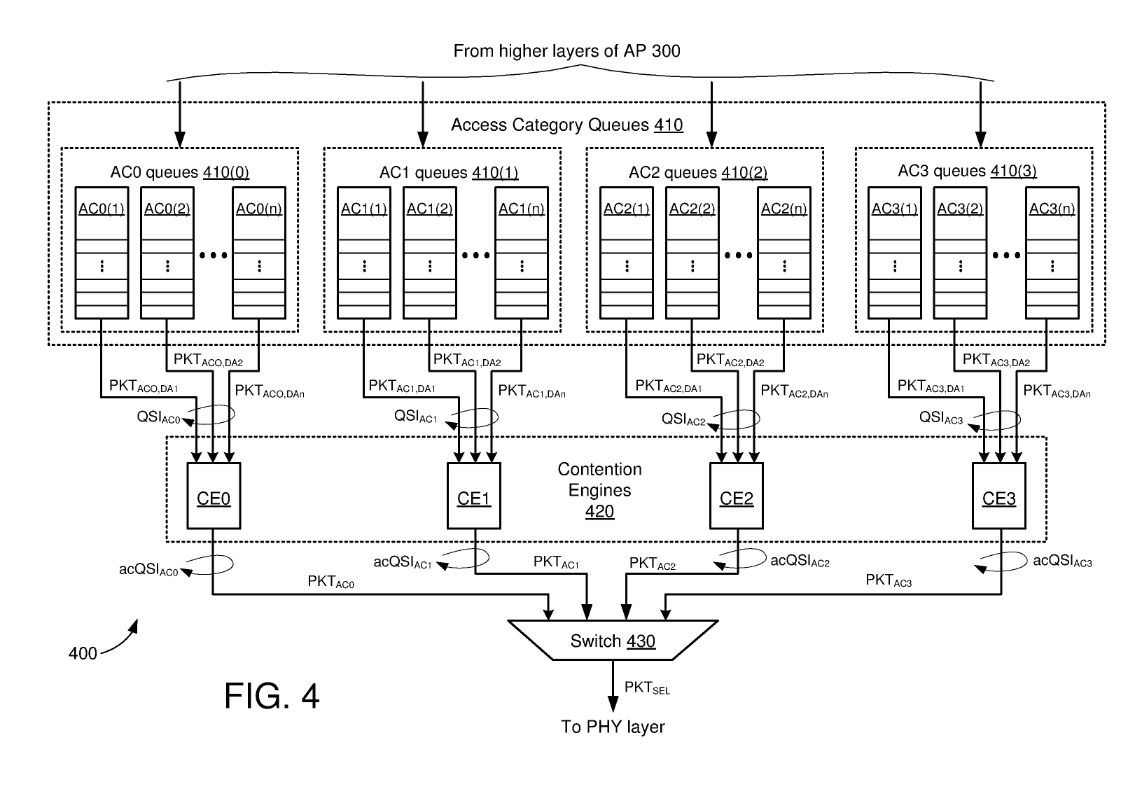

Memory 240 may include a number of packet queues 242. The packet queues 242 may store packets to be transmitted from STA 200 to one or more other wireless devices. For some embodiments, the memory 240 may include one or more packet queues 242 for each of a plurality of different priority levels or access categories, for example, as described in more detail below with respect to FIG. 4.

Memory 240 may also include a non-transitory computer-readable storage medium (e.g., one or more nonvolatile memory elements, such as EPROM, EEPROM, Flash memory, a hard drive, and so on) that may store the following software (SW) modules:
a frame formation and exchange software module 243 to facilitate the creation and exchange of frames (e.g., management frames, control frames, and data frames), for example, as described below for one or more operations of FIG. 5; and
an AP/band switching software module 244 to facilitate switching the association of STA 200 between APs and/or to facilitate switching the operation of STA 200 between different frequency bands, for example, as described below for one or more operations of FIG. 5.
   Each software module includes instructions that, when executed by processor 230, may cause STA 200 to perform the corresponding functions. The non-transitory computer-readable medium of memory 240 thus includes instructions for performing all or a portion of the operations described below with respect to FIG. 5.

Processor 230 may be any one or more suitable processors capable of executing scripts or instructions of one or more software programs stored in STA 200 (e.g., within memory 240). For example, processor 230 may execute the frame formation and exchange software module 243 to facilitate the creation and exchange of frames (e.g., management frames, control frames, and data frames). Processor 230 may also execute the AP/band switching software module 244 to facilitate switching the association of STA 200 between APs and/or to facilitate switching the operation of STA 200 between different frequency bands.

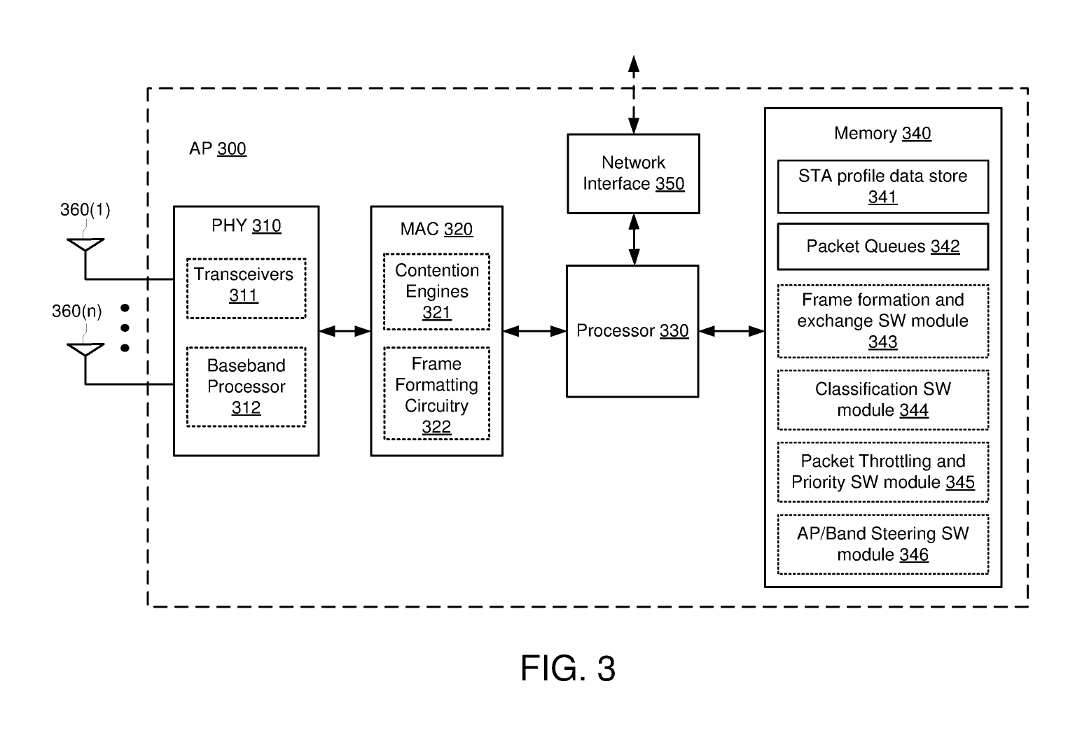

FIG. 3 shows an example AP 300 that may be one embodiment of one or more of the APs 110A-110E of FIG. 1. AP 300 may include a PHY device 310 including at least a number of transceivers 311 and a baseband processor 312, may include a MAC 320 including at least a number of contention engines 321 and frame formatting circuitry 322, may include a processor 330, may include a memory 340, may include a network interface 350, and may include a number of antennas 250(1)-250(n).

The transceivers 311 may be coupled to antennas 360(1)-360(n), either directly or through an antenna selection circuit (not shown for simplicity). The transceivers 311 may be used to communicate wirelessly with one or more wireless devices (e.g., STAs), with one or more other APs, and/or with other suitable devices. Although not shown in FIG. 3 for simplicity, the transceivers 311 may include any number of transmit chains to process and transmit signals to other wireless devices via antennas 360(1)-360(n), and may include any number of receive chains to process signals received from antennas 360(1)-360(n). Thus, for example embodiments, the AP 300 may be configured for MIMO operations. The MIMO operations may include SU-MIMO operations and MU-MIMO operations.

The baseband processor 312 may be used to process signals received from processor 330 and/or memory 340 and to forward the processed signals to transceivers 311 for transmission via one or more of antennas 360(1)-360(n), and may be used to process signals received from one or more of antennas 360(1)-360(n) via transceivers 311 and to forward the processed signals to processor 330 and/or memory 340.

The contention engines 321 may contend for access to the shared wireless medium, and may also store packets for transmission over the shared wireless medium. For some embodiments, AP 300 may include one or more contention engines 321 for each of a plurality of different access categories. For other embodiments, the contention engines 321 may be separate from MAC 320. For still other embodiments, the contention engines 321 may be implemented as one or more software modules (e.g., stored in memory 340 or within memory provided within MAC 320) containing instructions that, when executed by processor 330, perform the functions of contention engines 321 described below.

The frame formatting circuitry 322 may be used to create and/or format frames received from processor 330 and/or memory 340 (e.g., by adding MAC headers to PDUs provided by processor 330), and may be used to re-format frames received from PHY device 310 (e.g., by stripping MAC headers from frames received from PHY device 310).

The network interface 350 may be used to communicate with the WAN 130 shown in FIG. 1 and/or with a WLAN server (not shown for simplicity) associated with WLAN 120 of FIG. 1, either directly or via one or more intervening networks and to transmit signals.

For purposes of discussion herein, MAC 320 is shown in FIG. 3 as being coupled between PHY device 310 and processor 330. For actual embodiments, PHY device 310, MAC 320, processor 330, memory 340, and/or network interface 350 may be connected together using one or more buses (not shown for simplicity).

Memory 340 may include a STA profile data store 341 that stores profile information for a plurality of STAs. The profile information for a particular STA may include, for example, its MAC address, supported data rates, connection history with AP 300, device type, traffic flow, and/or bandwidth history, and any other suitable information pertaining to or describing the operation of the STA.

Memory 340 may also include a number of packet queues 342. The packet queues 342 may store packets to be transmitted from AP 300 to one or more other wireless devices. For some embodiments, the memory 340 may include one or more packet queues 342 for each of a plurality of different priority levels or access categories, for example, as described in more detail below with respect to FIG. 4. In addition, for at least some embodiments, memory 340 may include packet queues for a plurality of different destinations (e.g., STAs), for example, as described in more detail below with respect to FIG. 4.

Memory 340 may also include a non-transitory computer-readable medium (e.g., one or more nonvolatile memory elements, such as EPROM, EEPROM, Flash memory, a hard drive, and so on) that can store the following software modules:
a frame formation and exchange software module 343 to facilitate the creation and exchange of frames (e.g., management frames, control frames, and data frames), for example, as described below for one or more operations of FIG. 5;
a classification software module 344 to classify incoming packets and/or traffic flows into a number of traffic types, for example, as described below for one or more operations of FIG. 5;
a packet throttling and priority software module 345 to selectively throttle incoming traffic flows and/or to dynamically change the priority level of a number of selected packets or flows, for example, as described below for one or more operations of FIG. 5; and
an AP/band steering software module 346 to facilitate steering wireless devices such as STA 200 between different APs and/or between different frequency bands based on classified traffic types, priority levels, traffic flow characteristics, movement of the wireless devices, and/or QoS attributes, for example, as described below with respect to FIG. 5.
   Each software module includes instructions that, when executed by processor 330, cause AP 300 to perform the corresponding functions. The non-transitory computer-readable medium of memory 340 thus includes instructions for performing all or a portion of the operations described below with respect to FIG. 5.

Processor 330 may be any suitable processor capable of executing scripts or instructions of one or more software programs stored in AP 300 (e.g., within memory 340). For example, processor 330 may execute the frame formation and exchange software module 343 to facilitate the creation and exchange of frames (e.g., management frames, control frames, and data frames). The processor 330 may execute the classification software module 344 to classify incoming packets and/or traffic flows into a number of traffic types. The processor 330 may execute the packet throttling and priority software module 345 to selectively throttle incoming traffic flows and/or to dynamically change the priority level of a number of selected packets or flows. The processor 330 may execute the AP/band steering software module 346 to facilitate steering wireless devices (e.g., one or more of stations STA1-STA4 of FIG. 1 and/or STA 200 of FIG. 2) between different APs and/or between different frequency bands based on classified traffic types, priority levels, traffic flow characteristics, movement of the wireless devices, and/or QoS attributes.

FIG. 4 depicts a packet contention and transmission system 400 that may be implemented within the AP 300 of FIG. 3. For some embodiments, the system 400 may be implemented by or correspond to MAC 320, processor 330, and/or memory 340 of FIG. 3. For other embodiments, the system 400 may be a separate device or chip coupled to PHY device 310, MAC 320, processor 330, and memory 340 of FIG. 3. The system 400 is shown to include access category queues 410, contention engines 420, and a switch 430. The access category queues 410, which may be one embodiment of the packet queues 342 of FIG. 3, includes four sets of AC queues 410(0)-410(3) that may receive data packets from an upper layer (not shown for simplicity) of the AP 300 (e.g., after packet classification operations that determine the TID and DA of downlink data to be queued in the access category queues 410).

The first set of access category queues 410(0) is to queue downlink data classified by a TID corresponding to the first access category (AC0), and includes a plurality of individual packet queues AC0(1)-AC0(n) each for storing packets to be transmitted to a corresponding one of a plurality of destination addresses DA1-DAn. The second set of access category queues 410(1) is to queue downlink data classified by a TID corresponding to the second access category (AC1), and includes a plurality of individual packet queues AC1(1)-AC1(n) each for storing packets to be transmitted to a corresponding one of the plurality of destination addresses DA1-DAn. The third set of access category queues 410(2) is to queue downlink data classified by a TID corresponding to the third access category (AC2), and includes a plurality of individual packet queues AC2(1)-AC2(n) each for storing packets to be transmitted to a corresponding one of the plurality of the destination addresses DA1-DAn. The fourth set of access category queues 410(3) is to queue downlink data classified by a TID corresponding to the fourth access category (AC3), and includes a plurality of individual packet queues AC3(1)-AC3(n) each for storing packets to be transmitted to a corresponding one of the plurality of destination addresses DA1-Dn.

As noted above, each of the destination addresses DA1-DAn identifies a corresponding STA to which the AP 300 may transmit data. For purposes of discussion herein, STA1 has a destination address of DA1, STA2 has a destination address of DA2, STA3 has a destination address of DA3, and STA4 has a destination address of D4. Thus, for the first access category AC0, packet queue AC0(1) may store packets to be delivered to STA1, packet queue AC0(2) may store packets to be delivered to STA2, and so on; for the second access category AC1, packet queue AC1(1) may store packets to be delivered to STA1, packet queue AC1(2) may store packets to be delivered to STA2, and so on; for the third access category, packet queue AC2(1) may store packets to be delivered to STA1, packet queue AC2(2) may store packets to be delivered to STA2, and so on; for the fourth access category AC3, packet queue AC3(1) may store packets to be delivered to STA1, packet queue AC3(2) may store packets to be delivered to STA2, and so on. Thus, each set of access category queues 410(0)-410(3) may queue downlink data on a per-user basis.

The contention engines 420, which may be one embodiment of contention engines 321 of FIG. 3, are shown to include four individual contention engines CE0-CE3. The first contention engine CE0 includes an input to receive packets from the first set of access category queues 410(0), includes an output coupled to switch 430, and is to contend for medium access on behalf of the first access category AC0. The second contention engine CE1 includes an input to receive packets from the second set of access category queues 410(1), includes an output coupled to switch 430, and is to contend for medium access on behalf of the second access category AC1. The third contention engine CE2 includes an input to receive packets from the third set of access category queues 410(2), includes an output coupled to switch 430, and is to contend for medium access on behalf of the third access category AC2. The fourth contention engine CE3 includes an input to receive packets from the fourth set of access category queues 410(3), includes an output coupled to switch 430, and is to contend for medium access on behalf of the fourth access category AC3. Thus, each of contention engines CE0-CE3 may queue downlink data on a per-AC basis.

Each of the contention engines CE0-CE3 is responsible for contending for medium access for its corresponding access category. To ensure that access categories associated with higher data priority levels are granted medium access faster and/or more frequently than access categories associated with lower data priority levels, the contention engines CE0-CE3 may select from different ranges of contention period back-off values. More specifically, the contention engines associated with higher priority access categories select from a lower range of back-off values than the contention engines associated with lower priority access categories. In this manner, contention engines associated with higher priority access categories may have a greater chance of winning medium access for any given contention period than contention engines associated with lower priority access categories. Thus, for the example embodiments, contention engine CE0 may select from the lowest range of back-off values, contention engine CE1 may select from the second lowest range of back-off values, contention engine CE2 may select from the third lowest range of back-off values, and contention engine CE3 may select from the highest range of back-off values. For at least some embodiments, the numerical ranges from which the contention engines CE0-CE3 select back-off values overlap one another.

The switch 430 includes inputs to receive packets from contention engines CE0-CE3, and an output coupled to a PHY layer (e.g., transceiver 311 of FIG. 3) of AP 300. In operation, the switch 430 forwards one of the packets PKT_{AC0}-PKT_{AC3} provided from respective contention engines CE0-CE3 as the selected packet (PKT_{SEL}) to the PHY layer, which in turn transmits PKT_{SEL} on the wireless medium. More specifically, one of the contention engines CE0-CE3 that wins medium access for a given contention period forwards the corresponding one of PKT_{AC0}-PKT_{AC3} as PKT_{SEL} to be transmitted onto the wireless medium.

The STA 200 of FIG. 2 may include a contention and transmission system similar to the contention and transmission system 400 of FIG. 4. In some aspects, the contention and transmission system included within the STA 200 may include only one queue for each of access categories AC0-AC3 (e.g., because the STA 200 typically transmits data only to an associated AP, and thus there is only one DA value for uplink data queued in the STA 200). In other aspects, the contention and transmission system included within the STA 200 may include separate DA packet queues for each access category, which may allow the STA 200 to support transmission of traffic for multiple DAs.

As noted above, during each contention period, each of contention engines CE0-CE3 contends for medium access. The contention engine that wins medium access for a given contention period is granted a TXOP during which the winning contention engine may transmit one or more packets belonging to the corresponding AC for a particular DA onto the wireless medium. When the TXOP ends, or there are no more packets left to be sent to that particular DA, the winning contention engine relinquishes control of the medium, and may subsequently resume serving its corresponding access category queues 410 during its next TXOP (e.g., corresponding to the next contention period win).

The period of time associated with each of the individual packet queues of a corresponding set of AC queues 410 being served once is referred to herein as the queue service interval (QSI), as indicated in FIG. 4. More specifically, the value of QSI may be defined, for at least one embodiment, as the period of time between the completion of service for a given packet queue of the corresponding access category and the commencement of the next service of the given packet queue. This period of time includes the time taken to serve the other packet queues of the corresponding access category before returning to the given packet queue. Thus, the value of QSI may be a metric of the period of time between successive services of a given user's traffic belonging to a specific access category.

For example, the value of QSI_{AC0} denotes the amount of time for contention engine CE0 to serve all of its corresponding packet queues AC0(1)-AC0(n) one time in a round-robin manner, the value of QSI_{AC1} denotes the amount of time for contention engine CE1 to serve all of its corresponding packet queues AC1(1)-AC1(n) one time in a round-robin manner, the value of QSI_{AC2} denotes the amount of time for contention engine CE2 to serve all of its corresponding packet queues AC2(1)-AC2(n) one time in a round-robin manner, and the value of QSI_{AC3} denotes the amount of time for contention engine CE3 to serve all of its corresponding packet queues AC3(1)-AC3(n) one time in a round-robin manner.

The period of time between successive grants of medium access for a given one of the contention engines CE0-CE3 is referred to herein as the access category's queue service interval (acQSl), as indicated in FIG. 4. More specifically, the value of acQSl may be defined, for at least one embodiment, as the amount of time that a contention engine of a given access category waits between successive grants of medium access. Thus, the value of acQSl may account for the amount of time that a packet of the given access category spends contending with packets of other access categories and with other users of the medium.

Referring again to FIG. 1, device steering operations performed by the root AP 110A may be based, at least in part, on classified traffic types, priority levels, traffic flow characteristics, movement of the wireless devices, and/or QoS demands of the stations STA1-STA4. If incoming packets (e.g., packets received by the root AP 110A from the WAN 130) include QoS markings, then the root AP 110A may use the QoS markings to prioritize and/or classify the packets into one of the aforementioned local traffic types: real-time traffic, streaming traffic, general traffic, and bulk traffic. Conversely, if the incoming packets do not include QoS markings, then the root AP 110A may analyze the packets (e.g., using deep packet inspection techniques) to prioritize and/or classify the packets into one of the aforementioned local traffic types. Referring also to FIG. 4, for at least some embodiments, the root AP 110A may direct the incoming packets to a selected one of the sets of AC queues 410(0)-410(3) based, at least in part, on the priority and/or classification of the incoming packets (e.g., as determined by the root AP 110A).

For at least one implementation, the root AP 110A may inspect incoming packets and determine whether the corresponding flow may be classified as real-time traffic (e.g., rather than non-time critical traffic) based on at least one of the following factors: (1) whether the flow is a user datagram protocol (UDP) or a transmission control protocol (TCP), (2) the total load of the flow, (3) the duration of the flow, and (4) the flow's destination. For example, packets transmitted using the UDP may indicate that the flow is real-time traffic (e.g., due to the relatively low overhead and absence of error correction, as compared with TCP traffic), while a relatively long duration may indicate that the flow is not real-time traffic (e.g., the relatively long duration may indicate a bulk back-up operation).

In addition or as an alternative, the root AP 110A may analyze the incoming packets to determine whether the corresponding flow is one of the following traffic types: gaming traffic, voice (e.g., VoIP) traffic, downlink (DL) traffic, and greedy traffic. Thereafter, the root AP 110A may dynamically modify steering operations for a given device based, at least in part, on the type of traffic directed towards the device.

### Gaming Traffic

For one example, if the root AP 110A determines that a traffic flow associated with a given STA is associated with a gaming application, then the root AP 110A may opt to steer the given STA to the root AP 110A rather than to one of the repeater APs 110B-110E, even if the given STA is moving towards and/or is closer to one of the repeater APs 110B-110E than to the root AP 110A. More specifically, because gaming traffic is time-sensitive and insensitive to delays, it may be desirable to minimize the number of hops in the WLAN 120 (e.g., the number of APs 110A-110E through which packets are routed before they reach the given STA). Thus, in some aspects, associating the given STA with the root AP 110A may reduce the number of hops for such gaming traffic. Further, if the given STA is facilitating a live interactive gaming application (e.g., a first-person shooter gaming application), then the root AP 110A may not steer the given STA to another AP or to another frequency band (e.g., to minimize next-hop delays and re-association delays) unless the root AP 110A detects a pause in the game. When the root AP, or the current AP that the STA is associated with, detects that the gaming traffic has paused, then the STA may be steered to a different AP (e.g., the best available AP).

For another example, if the root AP 110A determines that STA2 and STA3 are playing a gaming application with each other, then the root AP 110A may steer STA2 and STA3 to the same AP (e.g., currently associated repeater AP 110C) to minimize the number of hops between STA2 and STA3.

### Voice Traffic

In some aspects, if the root AP 110A determines that a given STA is facilitating (or is about to facilitate) a VoIP call, then the root AP 110A may maintain the given STA on the 2.4 GHz frequency band to minimize the number of potential handovers (e.g., because 2.4 GHz wireless signals typically have a longer range than 5 GHz wireless signals). In other aspects, if the root AP 110A determines that congestion on the 2.4 GHz frequency band exceeds a threshold (and that congestion on the 5 GHz frequency band is below a threshold), then the root AP 110A may steer the given STA to the 5 GHz frequency band.

### Downlink Traffic

For some embodiments, if the root AP 110A detects that a given STA is receiving downlink (DL) data, then the root AP 110A may determine whether the DL data corresponds to real-time traffic versus general or bulk traffic, and then selectively prioritize the DL packets accordingly (e.g., so that real-time traffic is given a higher priority than non-time critical traffic). In some aspects, the root AP 110A may use the encoding resolution (e.g., 720 dpi versus 1080 dpi) of a given DL traffic flow to determine whether the given DL traffic flow corresponds to real-time traffic or to non-time critical traffic). Here, the encoding resolution of the DL traffic flow may dictate the steering decisions in order to minimize the number of hops for traffic with higher encoding resolution (e.g., for traffic requiring a higher goodput).

For one example, if a given DL traffic flow has a constant data rate that is greater than a threshold (e.g., a data rate above 4 Mbit/s), which may indicate that the DL traffic flow corresponds to streaming traffic or real-time traffic, then the root AP 110A may assign a relatively high priority to the given DL traffic flow (e.g., to ensure that the streaming traffic or real-time traffic has a higher priority than general or bulk traffic). For another example, if a given DL traffic flow has a data rate that approaches the maximum backhaul data rate, which may indicate that the given DL traffic flow is a relatively large download file corresponding to general or bulk traffic, then the root AP 110A may assign a relatively low priority to the given DL traffic flow (e.g., to ensure that general or bulk traffic has a lower priority than real-time traffic).

The root AP 110A may also analyze the inter-packet spacing of a traffic flow to classify the flow. For example, if the inter-packet spacing is relatively small (e.g., packets are received every 10 milliseconds), then the traffic flow is likely to be a real-time traffic flow. Conversely, if the inter-packet spacing is relatively large (e.g., packets are received every few hundred milliseconds), then the traffic flow is likely to be a non-time critical traffic flow.

### Greedy Traffic

For some embodiments, device steering decisions may be based, at least in part, on whether a traffic flow is greedy or non-greedy. For one example, the root AP 110A may steer a greedy flow from an overloaded channel to a non-overloaded channel and/or may limit the flow's data rate to its current value (e.g., so the flow does not expand and overload the non-overloaded channel). For another example, if the root AP 110A detects congestion on a particular channel, then the root AP 110A may throttle non-time critical traffic in favor of real-time traffic so that the QoS guarantees of the real-time traffic flows are satisfied. The root AP 110A may also determine when a real-time traffic flow terminates, and thereafter perform opportunistic device steering operations.

FIG. 5 shows an illustrative flow chart depicting an example operation 500 for steering a wireless device between access points in a wireless local area network (WLAN). For the example of FIG. 5, the operation 500 may be performed by a first AP. In some aspects, the first AP may be the root AP 110A. In other aspects, the first AP may be one of the repeater APs 110B-110E of FIG. 1. For other embodiments, the operation 500 may be performed by any suitable wireless device.

The first AP may monitor a traffic flow associated with the wireless device (502), and may then identify a traffic type of the traffic flow based, at least in part, on one or more characteristics of the traffic flow (504). For some implementations, the first AP may classify the traffic flow as real-time traffic (e.g., gaming traffic or voice traffic), streaming traffic (e.g., video traffic), general traffic, or bulk traffic. Further, in some aspects, the traffic characteristics may include a data rate, a duration of the traffic flow, a length of the traffic flow, and a spacing between adjacent packets of the traffic flow. In other aspects, the traffic characteristics may include the traffic flow's QoS and application type.

Then, the first AP may selectively switch an association of the wireless device from the first AP to one of a number of second APs based, at least in part, on the identified traffic type (506). In some aspects, each of the number of second APs may be one of the repeater APs 110B-110E of FIG. 1. For one example, if the identified traffic type is real-time traffic, the first AP may maintain the association of the wireless device with the root AP (506A). For another example, if the identified traffic type is non-time critical traffic, the first AP may switch the association of the wireless device from the first AP to a selected one of the number of second APs based, at least in part, on a movement of the wireless device towards the selected second AP and a load of the selected second AP (506B).

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for selectively steering a wireless device in a wireless local area network (WLAN), the method comprising:
monitoring a traffic flow associated with the wireless device;
identifying a traffic type of the traffic flow based, at least in part, on one or more characteristics of the traffic flow; and
selectively switching an association of the wireless device between a first access point (AP) and a number of second APs based, at least in part, on the identified traffic type.

2. The method of claim 1, wherein the one or more characteristics includes at least one member of the group consisting of a data rate, a duration of the traffic flow, a length of the traffic flow, and a spacing between adjacent packets of the traffic flow.

3. The method of claim 1, wherein the selectively switching comprises:
in response to the identified traffic type being real-time traffic, maintaining the association of the wireless device with the first AP.

4. The method of claim 3, wherein the association of the wireless device with the first AP is maintained independently of a movement of the wireless device.

5. The method of claim 3, wherein the association of the wireless device with the first AP is maintained independently of a loading on either the first AP or the number of second APs.

6. The method of claim 3, wherein the real-time traffic is at least one member of the group consisting of voice traffic and gaming traffic.

7. The method of claim 1, wherein the selectively switching comprises:
in response to the identified traffic type being non-time critical traffic, switching the association of the wireless device from the first AP to a selected one of the number of second APs based, at least in part, on a movement of the wireless device towards the selected second AP and a load of the selected second AP.

8. The method of claim 1, wherein the traffic flow corresponds to a gaming application facilitated between the wireless device and another device, and the selectively switching comprises:
switching the association of the wireless device to one of the number of second APs with which the other device is associated.

9. The method of claim 1, wherein the first AP is a root AP and each of the number of second APs is a repeater AP.

10. The method of claim 1, wherein the first AP is a repeater AP and one of the number of second APs is a root AP.

11. A first access point (AP), comprising:
one or more processors; and
a memory storing one or more programs comprising instructions that, when executed by the one or more processors, cause the first AP to selectively steer a wireless device in a wireless local area network (WLAN) by:
monitoring a traffic flow associated with the wireless device;
identifying a traffic type of the traffic flow based, at least in part, on one or more characteristics of the traffic flow; and
selectively switching an association of the wireless device between the first AP and a number of second APs based, at least in part, on the identified traffic type.

12. The first AP of claim 11, wherein the one or more characteristics includes at least one member of the group consisting of a data rate, a duration of the traffic flow, a length of the traffic flow, and a spacing between adjacent packets of the traffic flow.

13. The first AP of claim 11, wherein execution of the instructions for the selectively switching causes the first AP to:
maintain the association of the wireless device with the first AP in response to the identified traffic type being real-time traffic.

14. The first AP of claim 13, wherein the association of the wireless device with the first AP is maintained independently of a movement of the wireless device.

15. The first AP of claim 13, wherein the association of the wireless device with the root AP is maintained independently of a loading on either the first AP or the number of second APs.

16. The first AP of claim 13, wherein the real-time traffic is at least one member of the group consisting of voice traffic and gaming traffic.

17. The first AP of claim 11, wherein execution of the instructions for the selectively switching causes the first AP to:
switch the association of the wireless device from the first AP to a selected one of the number of second APs based, at least in part, on a movement of the wireless device towards the selected second AP and a load of the selected second AP in response to the identified traffic type being non-time critical traffic.

18. The first AP of claim 11, wherein the traffic flow corresponds to a gaming application facilitated between the wireless device and another device, and execution of the instructions for the selectively switching causes the first AP to:
switch the association of the wireless device to one of the number of second APs with which the other device is associated.

19. A non-transitory computer-readable storage medium storing one or more programs containing instructions that, when executed by one or more processors of a first access point (AP), cause the first AP to selectively steer a wireless device in a wireless local area network (WLAN) by performing operations comprising:
monitoring a traffic flow associated with the wireless device;
identifying a traffic type of the traffic flow based, at least in part, on one or more characteristics of the traffic flow; and
selectively switching an association of the wireless device between the first AP and a number of second APs based, at least in part, on the identified traffic type.

20. The non-transitory computer-readable storage medium of claim 19, wherein the one or more characteristics includes at least one member of the group consisting of a data rate, a duration of the traffic flow, a length of the traffic flow, and a spacing between adjacent packets of the traffic flow.

21. The non-transitory computer-readable storage medium of claim 19, wherein execution of the instructions for the selectively switching causes the first AP to:
maintain the association of the wireless device with the first AP in response to the identified traffic type being real-time traffic.

22. The non-transitory computer-readable storage medium of claim 21, wherein the association of the wireless device with the first AP is maintained independently of a movement of the wireless device.

23. The non-transitory computer-readable storage medium of claim 21, wherein the association of the wireless device with the first AP is maintained independently of a loading on either the first AP or the number of second APs.

24. The non-transitory computer-readable storage medium of claim 21, wherein the real-time traffic is at least one member of the group consisting of voice traffic and gaming traffic.

25. The non-transitory computer-readable storage medium of claim 19, wherein execution of the instructions for the selectively switching causes the first AP to:
switching the association of the wireless device from the first AP to a selected one of the number of second APs based, at least in part, on a movement of the wireless device towards the selected second AP and a load of the selected second AP in response to the identified traffic type being non-time critical traffic.

26. The non-transitory computer-readable storage medium of claim 19, wherein the traffic flow corresponds to a gaming application facilitated between the wireless device and another device, and execution of the instructions for the selectively switching causes the first AP to:
switch the association of the wireless device to one of the number of second APs with which the other device is associated.

27. A first access point (AP) for selectively steering a wireless device in a wireless local area network (WLAN), the root AP comprising:
means for monitoring a traffic flow associated with the wireless device;
means for identifying a traffic type of the traffic flow based, at least in part, on one or more characteristics of the traffic flow; and
means for selectively switching an association of the wireless device between the first AP and a number of second APs based, at least in part, on the identified traffic type.

28. The first AP of claim 27, wherein the means for selectively switching is to:
maintain the association of the wireless device with the first AP in response to the identified traffic type being real-time traffic.

29. The first AP of claim 28, wherein the association of the wireless device with the first AP is maintained independently of a movement of the wireless device.

30. The first AP of claim 27, wherein the means for selectively switching is to:
switch the association of the wireless device from the first AP to a selected one of the number of second APs based, at least in part, on a movement of the wireless device towards the selected second AP and a load of the selected second AP if the identified traffic type is non-time critical traffic.
